(19) United States
(12) Patent Application Publication
(10) Pub. No.: US 2017/0372554 A1
(43) Pub. Date: Dec. 28, 2017

(54) NON-TRANSITORY COMPUTER-READABLE RECORDING MEDIUM, PROCESSING METHOD, PROCESSING APPARATUS, AND VENDING MACHINE

(71) Applicant: FUJITSU LIMITED, Kawasaki-shi (JP)

(72) Inventors: Akifumi Tokoro, Arakawa (JP); Takamitsu Ishii, Koutou (JP); Seiji Nakao, Kawasaki (JP)

(73) Assignee: FUJITSU LIMITED, Kawasaki-shi (JP)

(21) Appl. No.: 15/618,630

(22) Filed: Jun. 9, 2017

(30) Foreign Application Priority Data
Jun. 24, 2016 (JP) 2016-125493

(51) Int. Cl. G07F 9/02; G07F 9/10; G07F 9/00

(52) U.S. Cl. CPC G07F 9/02; G07F 9/006; G07F 9/10

(57) ABSTRACT

A processing apparatus obtains sales information from a control box of the vending machine which is connected to the computer via an interface compliant with an RS-232C standard, generates data of a screen corresponding to a specific path and including the sales information of the vending machine on a basis of the obtained sales information and transmits the data to a terminal, when having received a display request including a designation of the specific path, from the terminal.

### CROSS-REFERENCE TO RELATED APPLICATION(S)

This application is based upon and claims the benefit of priority of the prior Japanese Patent Application No. 2016-125493, filed on Jun. 24, 2016, the entire contents of which are incorporated herein by reference.

### FIELD

The embodiments discussed herein are related to a processing computer program (hereinafter, “processing program”), and the like.

### BACKGROUND

Conventionally, a system is known in which various types of information related to a vending machine are acquired, and the acquired information is provided, as a notification, for a terminal device of an administrator of the vending machine or a worker who replenishes the vending machine with commercial items. In the following sections, the administrator of the vending machine and the worker who replenishes the vending machine with the commercial items will collectively be referred to as users as appropriate.

FIG. 14 is a drawing illustrating an example of the conventional system. In the example illustrated in FIG. 14, the system includes a vending machine 5, a modem 5a, a count server 6a, a user server 6b, a dedicated terminal 7a, and a user terminal 7b. The vending machine 5 is connected to the modem 5a. The modem 5a is connected to the count server 6a via a 3rd Generation (3G) network 10a. The count server 6a is connected to the dedicated terminal 7a via a 3G network 10b. The count server 6a is connected to the user server 6b via a dedicated line. The user server 6b is connected to the user terminal 7b via a dedicated line.

The count server 6a is a server that acquires various types of information related to the vending machine 5 from the vending machine 5, via the 3G network 10a and the modem 5a. The various types of information related to the vending machine 5 include, for example, information about a sold quantity of the commercial items sold by the vending machine 5. In the following sections, the various types of information related to the vending machine 5 acquired by the count server 6a from the vending machine 5 will be referred to as “sales information”. Although FIG. 14 illustrates the example in which the count server 6a acquires the sales information from the vending machine 5, the count server 6a also acquires sales information from other vending machines via the 3G network 10a.

The count server 6a regularly acquires sales information from the vending machine 5 and accumulates the acquired sales information in a storage device. When having received an access related to the sales information from the dedicated terminal 7a via the 3G network 10b, the count server 6a transmits the sales information accumulated in the storage device to the dedicated terminal 7a. Further, when the dedicated terminal 7a has requested sales information at the current point in time, the count server 6a acquires the sales information from the vending machine 5 at the time when the request is made and provides the dedicated terminal 7a with the acquired sales information as a notification.

The count server 6a transmits the sales information accumulated in the storage device to the user server 6b via the dedicated line.

The user server 6b is a server that predicts a demand for the commercial items, on the basis of the sales information received from the count server 6a. The user server fib transmits a result of the demand prediction to the user terminal 7b via the dedicated line.

The user determines the quantity of commercial items with which the vending machine 5 is to be replenished and the taming with which the vending machine 5 is to be replenished, on the basis of the result of the demand prediction obtained from the user terminal 7b and the sales information obtained from the dedicated terminal 7a.

Patent Literature 1: Japanese Laid-open Patent Publication No. 11-296726

However, the conventional technique described above has a problem where it is not possible to provide the sales information of the vending machine.

For example, although the count server 6a in the conventional system is configured to regularly acquire, the sales information from the vending machine 5, because utilization costs for the 3G network 10a become higher when the frequency of the acquisition is higher, the sales information is acquired, in actuality, once or so in the middle of the night. Further, as described above, although the count server 6a is capable of acquiring the sales information in response to a request from the dedicated terminal 7a, implementing this function is not desirable from the viewpoint of the utilization costs. For these reasons, it is not possible to provide the sales information of the vending machine at times when, for example, the user wishes to obtain the sales information.

In the conventional system, the obtainment of the sales information is based on the premise that the count server 6a is provided, while the count server 6a is configured to perform data communication with a plurality of vending machines. For this reason, the count server 6a is expected to have a high capability, and the costs of maintaining the count server 6a are also high.

### SUMMARY

According to an aspect of an embodiment, a non-transitory computer-readable recording medium stores therein a processing computer program that causes a computer to execute a process including: obtaining sales information from a control box of the vending machine; which is connected to the computer via an interface compliant with an RS-232C standard; generating data of a screen corresponding to a specific path and including the sales information of the vending machine on a basis of the obtained sales information; and transmitting the data to a terminal, when having received a display request including a designation of the specific path, from the terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating a configuration of a system according to an embodiment of the present disclosure;

FIG. 2 is a drawing illustrating an example of a processing apparatus installed on the inside of a housing of a vending machine;

FIG. 3 is a drawing illustrating an example of installation of a wireless router provided for the vending machine;

FIG. 4 is a functional block diagram illustrating, a configuration of the processing apparatus;

FIG. 5 is a table illustrating an example of a data structure of a first count result table;

FIG. 6 is a table illustrating an example of a data structure of a third count result table;

FIG. 7 is a table illustrating an example of a data structure of a prediction table;

FIG. 8 is a drawing illustrating an example of screen information;

FIG. 9 is a drawing illustrating an example of sales information output from a control box;

FIG. 10 is a drawing for explaining a process performed by a predicting unit to generate the third count result table;

FIG. 11 is a table for explaining a process performed by a screen information generating unit;

FIG. 12 is a flowchart illustrating a processing procedure performed by the system according to the present embodiment;

FIG. 13 is a diagram illustrating an example of a hardware configuration of a computer that realizes the same functions as those of the processing apparatus; and

FIG. 14 is a drawing illustrating an example of a conventional system.

### DESCRIPTION OF EMBODIMENTS

Preferred embodiments of the present invention will be explained with reference to accompanying drawings. The present invention is not limited by these embodiments.

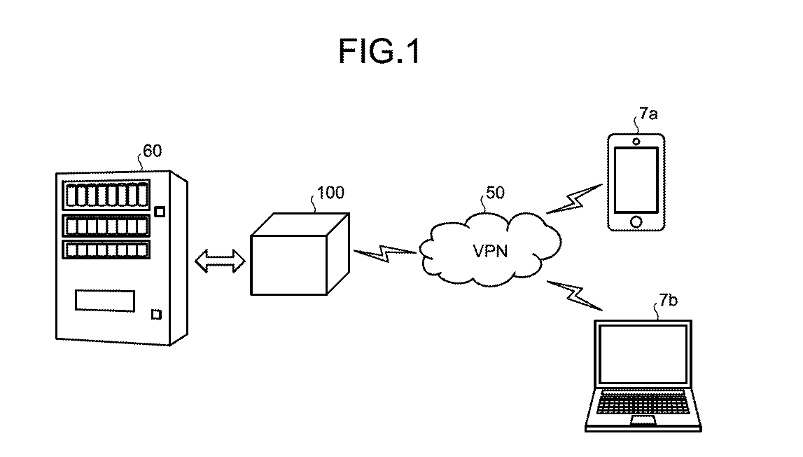

FIG. 1 is a drawing illustrating a configuration, of a system according to an embodiment of the present disclosure. As illustrated in FIG. 1, the system includes a vending machine 60, a processing apparatus 100, a dedicated terminal 7a, and a user terminal 7b. The vending machine 60 is connected to the processing apparatus 100 by a Recommended Standard (RS) 232C cable. As explained later, the processing apparatus 100 is installed on the inside of the vending machine 60. The processing apparatus 100 connects to a Virtual Private Network (VPN) 50 via a wireless Local Area Network (LAN) or the like and communicates with the dedicated terminal 7a and the user terminal 7b via the VPN 50.

The vending machine 60 is an apparatus that receives an input of money, a card, or the like from a client and that automatically provides the client with a commercial item selected by the client. Commercial items sold by the vending machine 60 are replenished by a worker. The vending machine 60 stores therein information that keeps predetermined commercial items in correspondence with column numbers. For each of the column numbers, the vending machine 60 has recorded therein the quantity of commercial items sold since the commercial items were replenished last time, information about an accumulated quantity of commercial items sold since the vending machine 60 was installed in the current location, as well as the quantity of commercial items in stock (hereinafter, “in-stock quantity”), and the like. In the following sections, the quantity of commercial items sold since the commercial items were replenished last time will be referred to as “sold quantity”, as appropriate. The accumulated quantity of commercial items sold since the vending machine 60 was installed in the current location will be referred to as “accumulated sold quantity”.

When having received a request for sales information from the processing apparatus 100 via the RS232C cable, the vending machine 60 outputs sales information to the processing apparatus 100. The sales information includes information about the sold quantities, the accumulated sold quantities, and information about the “in-stock” quantities of the commercial items.

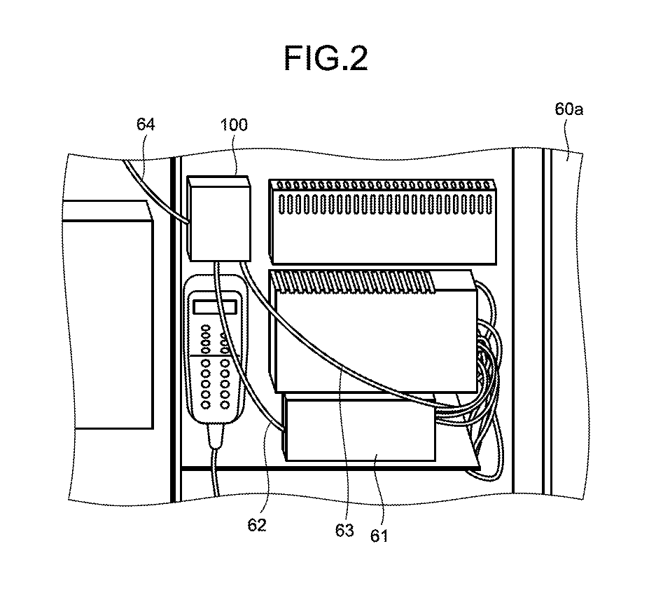

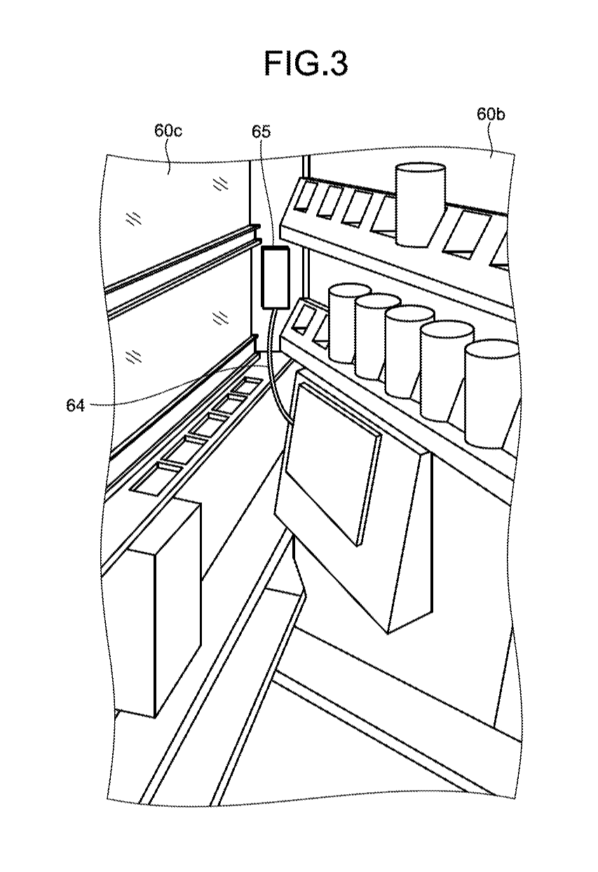

FIG. 2 is a drawing illustrating an example of the processing apparatus installed on the inside of a housing of the vending machine. In FIG. 2, a control box 61 is arranged on an inside 60a of the housing of the vending machine 60. The control box 61 and the processing apparatus 100 are connected to each other by an RS232C cable 62. Further, the processing apparatus 100 is connected to a power supply cable 63 provided on the inside 60a of the housing and thus obtains electric power. The processing apparatus 100 is connected to a wireless router 65 illustrated in FIG. 3 by a Universal Serial Bus (USB) cable 64. Because the inside 60a of the housing is configured by using a material (e.g., metal) that does not easily transmit wireless signals, the processing apparatus 100 performs wireless communication by using the wireless router 65 installed in a position other than the inside 60a.

The control box 61 is a device that manages the sales information of the vending ma chine 60. For example, the control box 61 stores therein the information that keeps the predetermined commercial items in correspondence with the column numbers, as well as time information indicating a time at which the commercial items were replenished last time. Every time the vending machine 60 sells a commercial item, the control box 61 counts a sold quantity and an accumulated sold quantity for each of the column numbers and stores the count results therein. When having received a request signal from the processing apparatus 100 via the RS232C cable 62, the control box 61 outputs the sales information to the processing apparatus 100.

FIG. 3 is a drawing illustrating an example of installation of the wireless router provided for the vending machine. The vending machine 60 has a region 60b where commercial-item samples are displayed. The wireless router 65 is arranged in the region 60b. Although FIG. 3 illustrates an example in which a cover 60c of the region 60b is open for the sake of convenience in the explanation, the cover 60c is usually closed other than when one or more types of commercial items are replaced with new types of commercial items. At least a part of the cover 60c is configured by using a member (e.g., made of plastic) that is able to transmit wireless signals. Further, at least a part of the cover 60c is configured with either a transparent member or a translucent member through which clients are able to view the commercial items. The wireless router 65 is connected to the USB cable 54 that is drawn from the rear face of the region 60b. The wireless router 65 performs data communication with the processing apparatus 100 installed on the rear face of the region 60b, via the USB cable 64.

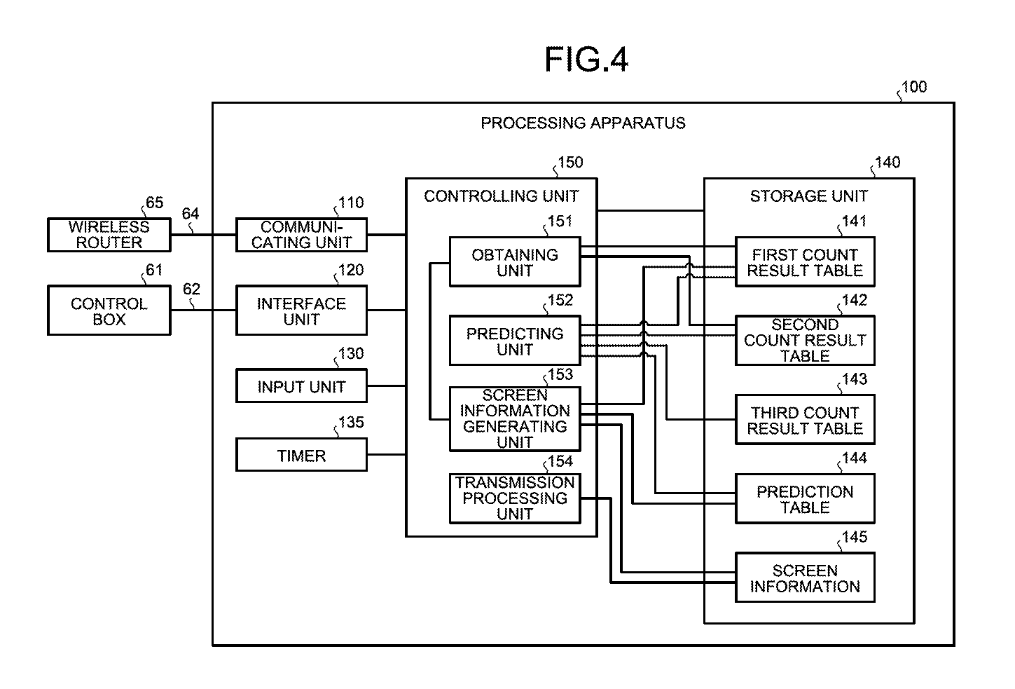

Next, a configuration of the processing apparatus 100 illustrated in FIGS. 1 and 2 will be explained. FIG. 4 is a functional block diagram illustrating the configuration of the processing apparatus. As illustrated in FIG. 4, the processing apparatus 100 includes a communicating unit 110, an interface unit 120, an input unit 130, a timer 135, a storage unit 140, and a controlling unit 150.

The communicating unit 110 is connected to the wireless router 65 via the USB cable 64. The wireless router 65 is a device that connects to the VPN 50 by using wireless signals. The controlling unit 150 (explained later) performs data communication with the dedicated terminal 7a and the user terminal 7b via the communicating unit 110, the USB cable 64, the wireless router 65, and the VPN 50.

The interface unit 120 is connected to the control box 61 by the RS232C cable 62. The controlling unit 150 (explained later) performs data communication with the control box 61 via the RS232C cable 62. Further, in accordance with vending machine communication standards including a Japan Vending Machine Manufacturers Association (JVMA) standard and a Vender Control Coca-Cola System (VCCS) standard, the interface unit 120 obtains the sales information from the control box 61 and outputs the obtained sales information to the controlling unit 150.

The input unit 130 is an input device used for inputting various types of information to the processing apparatus 100. The input unit 130 corresponds to, for example, a keyboard, an input button, a touch panel, and/or the like.

The timer 135 is a device that outputs information about a current date/time to the controlling unit 150 (explained later). Alternatively, the controlling unit 150 may obtain the information about the current date/time from an external device positioned in a network, by using the communicating unit 110.

The storage unit 140 includes a first count result table 141, a second count result table 142, a third count result table 143, a prediction table 144, and screen information 145. The storage unit 140 corresponds, for example, to a semiconductor memory element such as a Random Access Memory (RAM), a Read-Only Memory (ROM), a flash memory, or the like, or to a storage device such as a hard disk, an optical disk, or the like.

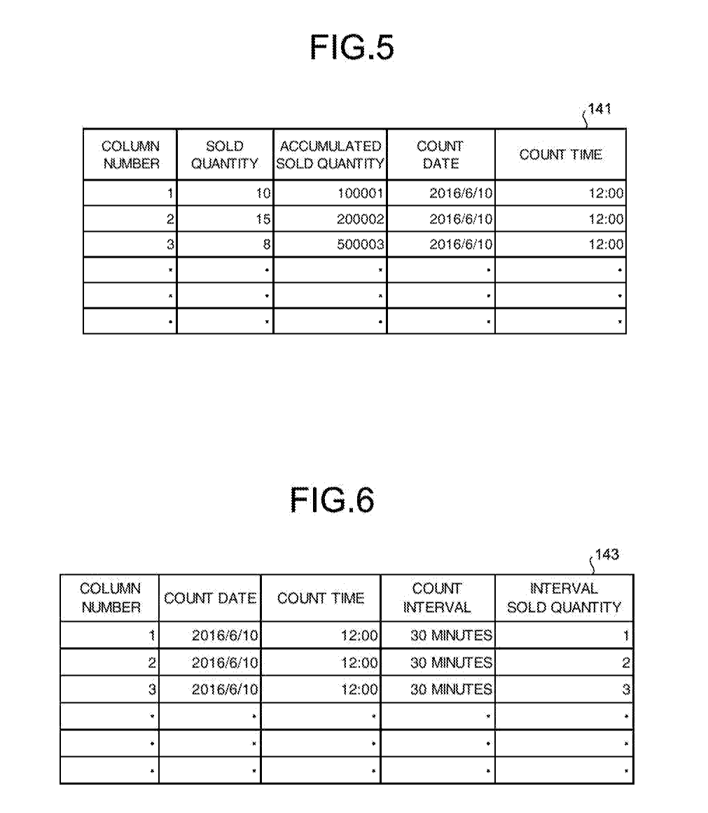

The first count result table 141 is a table storing therein the most up-to-date piece of sales information obtained from the control box 61. FIG. 5 is a table illustrating an example of a data structure of the first count result table. As illustrated in FIG. 5, the first count result table 141 keeps column numbers, sold quantities, accumulated sold quantities, count dates, and count times in correspondence with one another. Each of the column numbers is information uniquely identifying a different one of various types of commercial items sold by the vending machine 60. Each of the sold quantity values denotes the quantity of the corresponding type of commercial items sold since the commercial items were replenished last time. Each of the accumulated sold quantity values denotes the accumulated quantity of the corresponding type of commercial items sold since the vending machine 60 was installed in the current location. Each of the count dates denotes the date on which the corresponding piece of sales information was obtained. Each of the count times denotes the time at which the corresponding piece of sales information was obtained.

The second, count result table 142 is a table storing therein the sales information obtained from the control box 61 at an immediately-preceding occasion. For example, when the most up-to-date piece of sales information is stored into the first count result table 141, the piece of sales information that has so far been stored in the first count result table 141 is moved to the second count result table 142. The data structure of the second count result table 142 is the same as the data structure of the first count result table 141.

The third count result table 143 is a table storing therein information about sold quantities each corresponding to a period of time. FIG. 6 is a table illustrating an example of a data structure of the third count result table. As illustrated in FIG. 6, the third count result table 143 keeps column numbers, count dates, count times, count intervals, and interval sold quantities in correspondence with one another. The descriptions of the column numbers, the count dates, and the count times are the same as those of the column numbers, the count dates, and the count times provided with reference to FIG. 5. Each of the count intervals denotes the time interval between the count time in the first count result table 141 and the second count result table 142. Each of the interval sold quantity values denotes the quantity of the corresponding type of commercial items sold in the corresponding time interval.

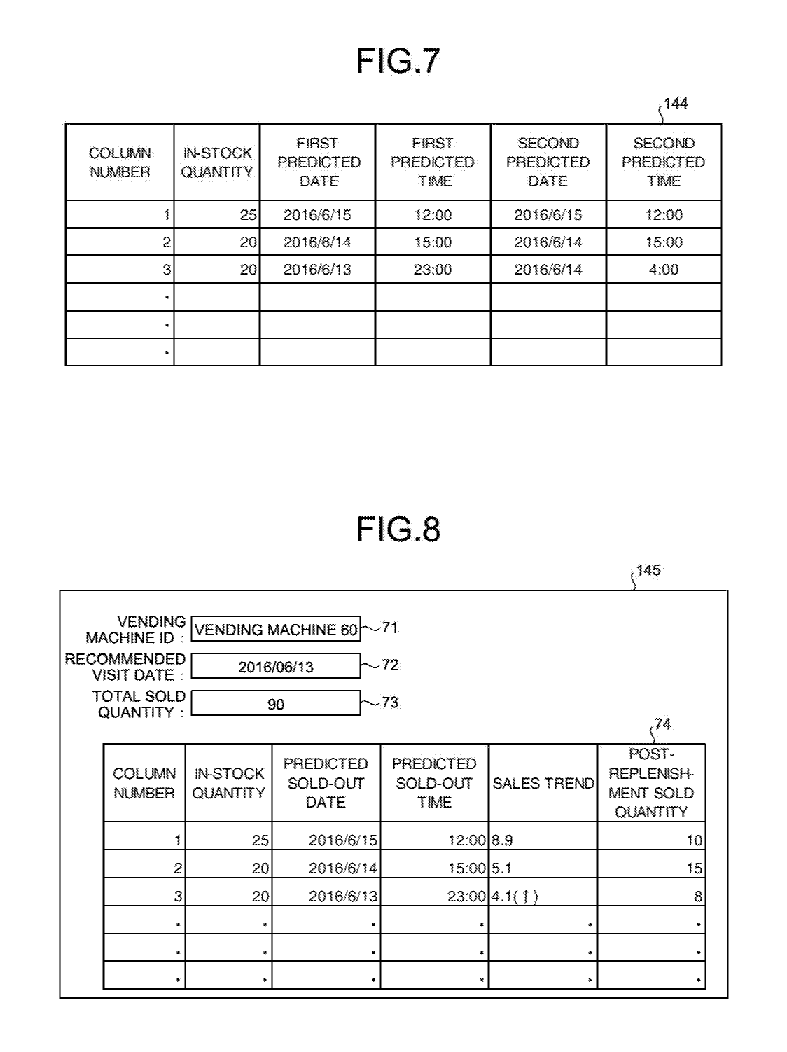

The prediction table 144 is a table storing therein information about a result of a prediction as to the date/time at which each of the various types of commercial items sold by the vending machine 60 is to be sold out. FIG. 7 is a table illustrating an example of a data structure of the prediction table. As illustrated in FIG. 7, the prediction table keeps column numbers, in-stock quantities, first predicted dates, first predicted times, second predicted dates, and second predicted times in correspondence with one another. Each of the column numbers is information uniquely identifying a different one of the various types of commercial items sold by the vending machine 60. Each of the in-stock quantity values denotes the quantity of a different one of the various types of commercial items remaining in the vending machine 60, the type being identified by the corresponding column number.

Each of the first predicted dates denotes a date on which the corresponding type of commercial items is predicted to be sold out, the prediction being calculated on the basis of the most up-to-date piece of sales information and the piece of sales information obtained at an immediately-preceding occasion (hereinafter, “immediately-preceding piece of sales information”). Each of the first predicted times denotes a time at which the corresponding type, of commercial items is predicted to be sold out, the prediction, being calculated on the basis of the most up-to-date piece of sales information and the immediately-preceding piece of sales information.

Each of the second predicted dates denotes a date on which the corresponding type of commercial items is predicted to be sold out, the prediction being calculated on the basis of the immediately-preceding piece of sales information and a piece of sales information obtained at the occasion that immediately precedes the immediately-preceding occasion (hereinafter, “second-to-last piece of sales information”). Each of the second predicted times denotes a time at which the corresponding type of commercial items is predicted to be sold out, the prediction being calculated on the basis of the immediately-preceding piece of sales information and the second-to-last piece of sales information.

The screen information 145 is information of a screen including various types of information about the sales information of the vending machine 60. FIG. 8 is a drawing illustrating an example of the screen information. As illustrated in FIG. 8, the screen information 145 includes regions 71, 72, and 73, as well as a table 74. The region 71 has registered therein information that uniquely identifies the pertinent vending machine. The region 72 has registered therein information about a date/time at which it is recommended to make a visit to the pertinent vending machine. The region 73 has registered therein information about a total quantity of the commercial items sold by the pertinent vending machine.

The table 74 keeps column numbers, in-stock quantities, predicted sold-out dates, predicted sold-out times, sales trend values, and sold quantities after a replenishment (hereinafter, “post-replenishment sold quantities”) in correspondence with one another. The descriptions of the column numbers and the in-stock quantities are the same as those presented above. Each of the predicted sold-out dates is a date corresponding to a relevant one of the first predicted dates illustrated in FIG. 7. Each of the predicted sold-out times is a time corresponding to a relevant one of the first predicted times illustrated in FIG. 7.

Each of the sales trend values is information approximately indicating how many commercial items of the corresponding type are sold in average during a predetermined period of time. Each of the post-replenishment sold quantity values is information indicating the quantity of the corresponding type of commercial items sold between the date/time when the commercial items were replenished last time and the current time.

Returning to the description of FIG. 4, the controlling unit 150 includes an obtaining unit 151, a predicting unit 152, a screen information generating unit 153, and a transmission processing unit 154. For example, the controlling unit 150 corresponds to an integrated device such as an Application Specific Integrated Circuit (ASIC), a Field Programmable Gate Array (FPGA), or the like. Alternatively, the controlling unit 150 corresponds to, for example, an electronic circuit such as a Central Processing Unit (CPU), a Micro Processing Unit (MPU), or the like.

The obtaining unit 151 is a processing unit that obtains the sales information from the control box 61 by regularly transmitting the request signal to the control box 61. In the present embodiment, the obtaining unit 151 is configured to transmit the request signal once every thirty minutes, as an example. However, possible embodiments are not limited to this example.

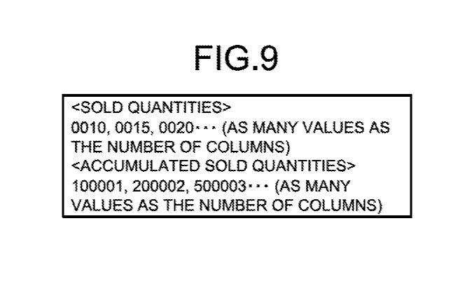

FIG. 9 is a drawing illustrating an example of the sales information output from the control box. For example, within the signals of the sales information output from the control box 61, the sold quantity values corresponding to the column numbers are sequentially output in the ascending order of the column numbers. When as many sold quantity values as the number of columns have been output, subsequently the accumulated sold quantity values corresponding to the column numbers are sequentially output in the ascending order of the column numbers. Further, although not illustrated, when as many accumulated sold quantity values as the number of columns have been output, subsequently the in-stock quantity values corresponding to the column numbers are sequentially output in the ascending order of the column numbers.

In the following sections, a process performed when the obtaining unit 151 has obtained the sales information for the first time and a process performed when the obtaining unit 151 has obtained sales information for the second time and thereafter will be explained sequentially.

First, the process performed when the obtaining unit 151 has received the sales information from the control box 61 for the first time will be explained. The obtaining unit 151 obtains, from the timer 135, information about the count date and the count time corresponding to the point in time when the obtaining unit 151 obtained the sales information. The obtaining unit 151 registers the column numbers, the sold quantities, the accumulated sold quantities, the count dates, and the count times included in the sales information, into the first count result table 141, so as to foe kept in correspondence with one another.

Next, the process performed when the obtaining unit 151 has obtained the sales information from the control box 61 for the second time and thereafter will be explained. The obtaining unit 151 obtains, from the timer 135, information about the count date and the count time corresponding to the point in time when the obtaining unit 151 obtained the sales information. The obtaining unit 151 moves the information stored in the first count result table 141 to the second count result table 142 and subsequently updates the first count result table 141 with the information included in the sales information in which the column numbers, the sold quantities, the accumulated sold quantities, the count dates, and the count times are kept in correspondence with one another.

In this situation, the obtaining unit 151 may output the identification information of the vending machine 60 included in the most up-to-date piece of sales information obtained from the control box 61, to the screen information generating unit 153.

The predicting unit 152 is a processing unit that predicts predicted sold-out dates and predicted sold-out times of the commercial items on the basis of the first count result table 141, the second count result table 142, and the in-stock quantities of the commercial items. For example, the predicting unit 152 sequentially performs a process of generating the third count result table 143 and a process of generating the prediction table 144.

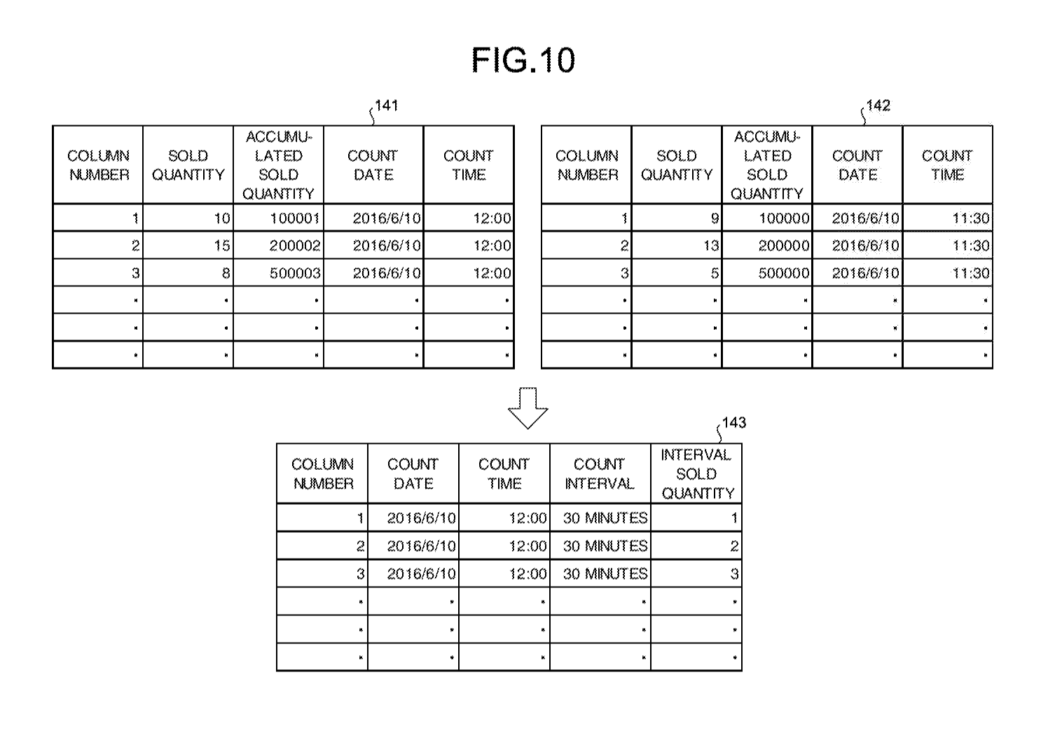

The predicting unit 152 generates the third count result table 143 on the basis of the first count result table 141 and the second count result table 142. FIG. 10 is a drawing for explaining the process performed by the predicting unit to generate the third count result table. In the following sections, an example will foe explained in which the predicting unit generates a record corresponding to column number “1” in the prediction table 144; however, the process of generating a record corresponding to column number “n” can similarly foe performed, where “n” is a natural number.

The predicting unit 152 obtains the count date “2016/6/10” and the count time “12:00” corresponding to column number “1” in the first count result table 141. The predicting unit 152 reregisters the obtained count date “2016/6/10” and the obtained count time “12:00” as the count date and the count time corresponding to column number “1” in the third count result table 143.

The predicting unit 152 calculates a count interval “30 minutes” by subtracting the count time “11:30” corresponding to column number “1” in the second count result table 142 from the count time “12:00” corresponding to column number “1” in the first count result table 141. The predicting unit 152 registers “30 minutes” as the count interval corresponding to column number “1” in the third count result table 143.

The predicting unit 152 calculates an interval sold quantity “1” by subtracting the accumulated sold quantity “100,000” corresponding to column number “1” in the second count result table 142 from the accumulated sold quantity “100,001” corresponding to column number “1” in the first count result table 141. The predicting unit 152 registers “1” as the interval sold quantity corresponding to column number “1” in the third count result table 143.

Every time the first count result table 141 and the second count result table 142 are updated, the predicting unit 152 generates a record corresponding to column number “n” to be registered into the third count result table 143 and additionally registers the generated record into the third count result table 143.

Subsequently, for each of the column numbers, the predicting unit 152 predicts a date and a time at which the type of commercial items corresponding to the column number is to be sold out, on the basis of the third count result table 143. For example, on the basis of Formula (1), the predicting unit 152 calculates a remaining period of time before each of the types of commercial items is to be sold out, the remaining period of time being indicated as the number of hours from the current date/time.

The remaining period of time=“the current in-stock quantity”/“an average sold quantity per unit time period”−α (1)

In Formula (1), the predicting unit 152 may use the in-stock quantity included in the most up-to-date piece of sales information as the current in-stock quantity. Alternatively, the predicting unit 152 may calculate the current in-stock quantity by subtracting the sold quantity included in the most up-to-date piece of sales information from the in-stock quantity obtained at the immediately-preceding occasion.

In Formula (1), the predicting unit 152 calculates the average sold quantity per unit time period on the basis of the third count result table 143. For example, with respect to column number “n”, the predicting unit 152 calculates an average time period of the count intervals during a predetermined period of time and an average value of the interval sold quantities. The predicting unit 152 calculates the average sold quantity per unit time period by dividing the average value of the interval sold quantities by the average time period of the count intervals. The symbol “α” in Formula (1) denotes a correction time that can be set by the administrator as appropriate. In the present embodiment, the example is explained in which the remaining period of time is calculated on the basis of Formula (1); however, the predicting unit 152 may calculate the remaining period of time on the basis of any other prediction algorithm.

The predicting unit 152 calculates a predicted sold-out date and a predicted sold-out time corresponding to column number “n”, by adding the remaining period of time to the current date/time. In the following sections, a process performed when the predicting unit 152 calculates predicted sold-out dates and predicted sold-out times for the first time and a process performed when the predicting unit 152 calculates predicted sold-out dates and predicted sold-out times for the second time and thereafter will sequentially be explained.

First, the process performed when the predicting unit 152 calculates the predicted sold-out dates and the predicted sold-out times for the first time will be explained. The predicting unit 152 registers an in-stock quantity, the predicted sold-out date, and the predicted sold-out time corresponding to each of the column numbers as an in-stock quantity, a first predicted date, and a first predicted time as to be kept in correspondence with the column number in the prediction table 144.

Next, the process performed when the predicting unit 152 calculates the predicted sold-out dates and the predicted sold-out times for the second time and thereafter will be explained. The predicting unit 152 moves the pieces of information about the first predicted dates and the first predicted times registered in the prediction table 144 into positions of the second predicted dates and the second predicted times. After that, the predicting unit 152 registers the in-stock quantity, the predicted sold-out date, and the predicted sold-out time corresponding to each of the column numbers, as an in-stock quantity, a first predicted date, and a first predicted time so as to be kept in correspondence with the column number in the prediction table 144.

Every time the third count result table 143 is updated, the predicting unit 152 calculates predicted sold-out dates and predicted sold-out times and updates the prediction table 144 with the calculated values.

Further, with respect to each of the column numbers, the predicting unit 152 may output an average sold quantity per unit time period as a sales trend value, to the screen information generating unit 153.

The screen information generating unit 153 is a processing unit that generates the screen information 145 on the basis of the prediction table 144. The screen information 145 is screen information displayed at an accessing source, when an access is received via the specific path. Further, the screen information generating unit 153 generates the screen information 145 in a Hypertext Markup Language (HTML) format. In the following sections, an example of a process performed by the screen information generating unit 153 to generate the screen information 145 will be explained.

The screen information generating unit 153 sets the pieces of information corresponding to the column numbers and being registered as the in-stock quantities, the first predicted dates, and the first predicted times in the prediction table 144, as the in-stock quantities, the predicted sold-out dates, and the predicted sold-out times in the table 74 illustrated in FIG. 8. The screen information generating unit 153 sets the pieces of information about the sales trend values corresponding to the column numbers that were received from the predicting unit 152 as the sales trend values in the table 74. The screen information generating unit 153 sets the pieces of information about the sold quantities corresponding to the column numbers that are stored in the first count result table 141 as the post-replenishment sold quantities in the table 74.

The screen information generating unit 153 receives the identification information of the vending machine from the obtaining unit 151 and sets the identification information of the vending machine 60 into the region 71 illustrated in FIG. 8. By referring to the predicted sold-out dates and the predicted sold-out times in the table 74, the screen information generating unit 153 identifies a set made up of a predicted sold-out date and a predicted sold-out time that is earliest from the current date/time as a recommended visit date. The screen information generating unit 153 sets the information about the identified recommended visit date into the region 72. The screen information generating unit 153 calculates a total sold quantity by calculating the sum of the sold quantities corresponding to the column numbers in the first count result table 141. The screen information generating unit 153 sets the information about the total sold quantity into the region 73.

The screen information generating unit 153 compares the first predicted dates and the first predicted times with the second predicted dates and the second predicted times in the prediction table 144 and judges whether or not a change has been made to any of the predicted dates and the predicted times.

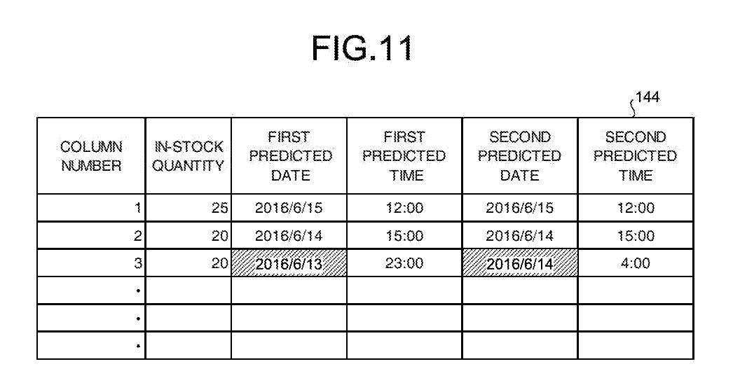

FIG. 11 is a table for explaining a process performed by the screen information generating unit. In the example illustrated in FIG. 11, with respect to the record corresponding to column number “3”, the first predicted date and the first predicted time are different from the second predicted date and the second predicted time. More specifically, the first predicted date and the first predicted time are “2016/6/13” and “23:00”, whereas the second predicted date and the second predicted time are “2016/6/14” and “4:00”. In this situation, the screen information generating unit 153 outputs information indicating that the predicted date/time has been changed, to the transmission processing unit 154.

Every time the prediction table 144 is updated, the screen information generating unit 153 updates the screen information 145 by performing the process described above. Further, the screen information generating unit 153 judges whether or not a change has been made to any of the predicted dates and the predicted times. When a change has been made to any of the predicted dates and the predicted times, the screen information generating unit 153 outputs information indicating that a change has been made to the predicted dates/times, to the transmission processing unit 154.

The transmission processing unit 154 is a processing unit that, when having received a display request including a designation of the specific path from either the dedicated terminal 7a or the user terminal 7b, transmits the screen information 145 to the dedicated terminal 7a or the user terminal 7b that made the display request. The specific path received by the transmission processing unit 154 is a unique path used for browsing the screen information 145 generated from the sales information of the vending machine 60 and is different from any of the paths used for browsing other pieces of screen information generated from sales information of other vending machines.

Further, in an address table (not illustrated), the transmission processing unit 154 has stored address information of the dedicated terminal 7a or the user terminal 7b that made the display request including the designation of the specific path. When having received the information indicating that a change has been made to the predicted dates/times from the screen information generating unit 153, the transmission processing unit 154 transmits the updated screen information 145, by using the address information stored in the address table as the destination thereof.

Alternatively, when having received the information indicating that a change has been made to the predicted dates/times, the transmission processing unit 154 may send a notification about the specific path used for accessing the screen information 145, by using the address information stored in the address table as the destination, thereof. The transmission processing unit 154 sends the notification via an electronic mail or the like. When having received the notification, the dedicated terminal 7a or the user terminal 7b accesses the processing apparatus 100 by using the specific path included in the notification and receives the screen information 145.

For example, when having received the notification, the dedicated terminal 7a or the user terminal 7b announces that a change has been made to the predicted times/dates on a display screen (not illustrated) and further displays a button to select whether or not the user wishes to check the predicted dates/times. When having detected that the displayed button has been pressed by the user, the dedicated terminal 7a or the user terminal 7b accesses the processing apparatus 100 by using the specific path included in the notification and further obtains and displays the screen information 145.

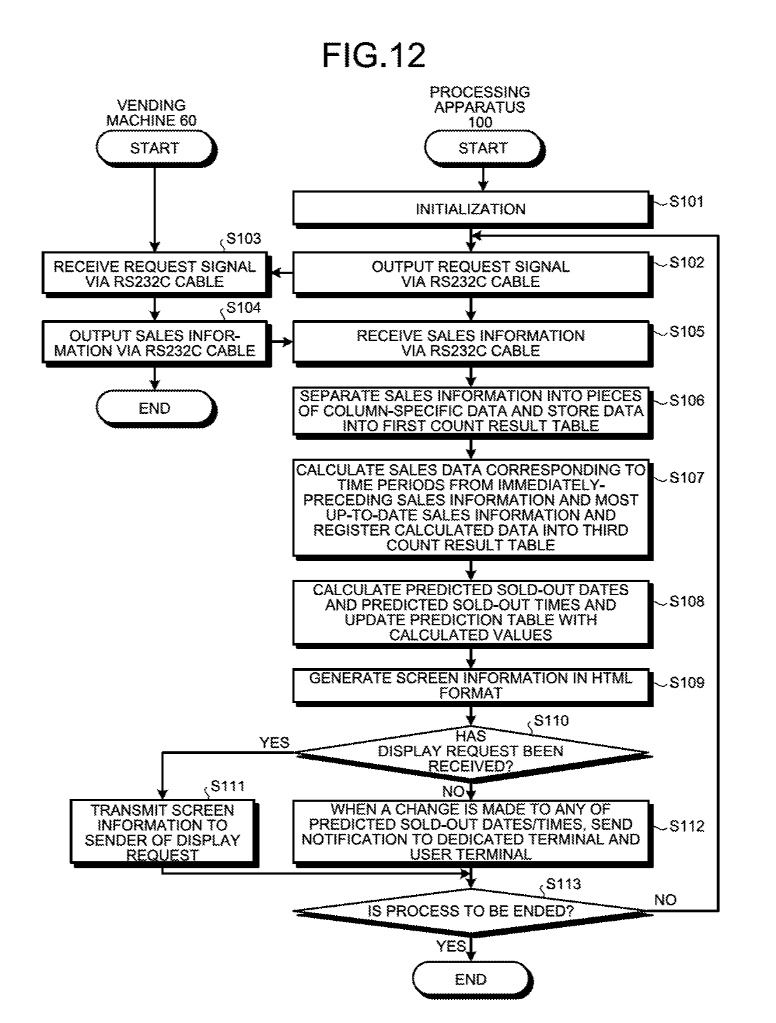

Next, an example of a processing procedure performed by the system of the present embodiment will be explained. FIG. 12 is a flowchart illustrating the processing procedure performed by the system according to the present embodiment. As illustrated in FIG. 12, the processing apparatus 100 performs an initialization process (step S101). The obtaining unit 151 included in the processing apparatus 100 transmits a request signal to the vending machine 60, via the RS232C cable 62 (step S102).

The control box 61 of the vending machine 60 receives the request signal via the RS232c cable 62 (step S103). The control box 61 outputs the sales information to the processing apparatus 100 via the RS232C cable 62 (step S104).

The obtaining unit 151 receives the sales information via the RS232C cable 62 (step S105). The obtaining unit 151 separates the sales information into pieces of column-specific data and stores the pieces of column-specific data into the first count result table 141 (step S106). Further, at step S106, the obtaining unit 151 updates the second count result table 142.

The predicting unit 152 included in the processing apparatus 100 calculates sold quantities corresponding to different time periods, on the basis of the immediately-preceding piece of sales information and the most up-to-date piece of sales information and registers the calculated sold quantities into the third count result table 143 (step S107). The predicting unit 152 calculates predicted sold-out dates and predicted sold-out times and further updates the prediction table 144 with the calculated values (step S108).

The screen information generating unit 153 included in the processing apparatus 100 generates the screen information 145 in an HTML format (step S109). The transmission, processing unit 154 included in the processing apparatus 100 judges whether or not a display request has been received (step S110). When ho display request has been received (step S110: No), the transmission processing unit 154 proceeds to step S112.

On the contrary, when a display request has been received (step S110: Yes), the transmission processing unit 154 transmits the screen information 145 to the sender of the display request (step S111) and proceeds to step S113.

When a change has been made to any of the predicted sold-out dates/times, the transmission processing unit 154 included in the processing apparatus 100 sends the notification to the dedicated terminal 7a and the user terminal 7b (step S112). When the process is not to be ended (step S113: No), the processing apparatus 100 proceeds to step S102. On the contrary, when the process is to be ended (step S113: Yes), the processing apparatus 100 ends the process.

Next, advantageous effects of the processing apparatus 100 according to the present embodiment will be explained. The processing apparatus 100 obtains the sales information from the control box 61 of the vending machine 60, via the RS232C cable 62. Further, the processing apparatus 100 generates the screen information 145 corresponding to the specific path, on the basis of the sales information. When having received the display request including the designation of the specific path, the processing apparatus 100 transmits the screen information 145 to the sender of the display request. In this manner, it is possible to provide the sales information of the vending machine 60.

Further, because the processing apparatus 100 directly obtains the sales information from the control box 61 via the RS232C cable 62 that is installed in the vending machine 60 as a part of standard equipment, it is possible to easily attach the processing apparatus 100 to the existing vending machine 60. Further, unlike the conventional technique, because the sales information is obtained without using the communication through a 3G network, it is possible to lower the communication costs.

The processing apparatus 100 obtains the sales information in the JVMA format from the control box 61 and generates the screen information 145. With this arrangement, because the format used by the vending machine 60 as a standard specification is applicable without any modification, it is possible to easily attach the processing apparatus 100 to the existing vending machine 60.

The processing apparatus 100 and the dedicated terminal 7a and the user terminal 7b are connected to each other via the VPN 50 so that the information is exchanged via the VPN 50. Consequently, it is possible to lower the communication costs compared to the situation where the communication is performed via a 3G network.

The dedicated terminal 7a and the user terminal 7b obtain the screen information 145 from the processing apparatus 100 by designating the screen information 145 about the sales information of the vending machine 60 with the use of the specific path unique to the vending machine 60. Consequently, the terminals are each able to refer to the screen information 145 by simply using the specific path corresponding to the vending machine 60.

The processing apparatus 100 generates the screen information 145 in the HTML format and transmits the generated screen information 145 to the sender of the display request. Consequently, by simply having a general-purpose browser installed therein, the terminal device is able to refer to the screen information 145.

Because the processing apparatus 100 specifies the predicted sold-out dates/times of the commercial items on the basis of the sales information, it is possible to improve efficiency of the replenishing work of the worker who replenishes the vending machine 60 with the commercial items. Further, when a change has been made to any of the predicted sold-out dates/times, the processing apparatus 100 notifies the dedicated terminal 7a and the user terminal 7b of the predicted sold-out dates/times after the change. Consequently, it is possible to prevent the vending machine 60 from selling out the commercial items and the like, even when a change has occurred in the sales trend, and the original predicted dates/times are no longer correct.

When providing the dedicated terminal 7a and the user terminal 7b with the various types of notifications, the processing apparatus 100 arranges each of the notifications to include the information about the specific path corresponding to the screen information 145. Consequently, the dedicated terminal 7a and the user terminal 7b that receive the notifications are able to easily access the screen information 145.

Although the processing apparatus 100 is provided on the inside of the vending machine 60 where the wireless radio waves do not easily reach. However, because the processing apparatus 100 is connected to the wireless router 65, and the wireless router 65 is arranged in the region where wireless communication with the outside is possible via the member that is able to transmit the wireless signals. With this arrangement, the processing apparatus 100 is able to easily connect to the VPN.

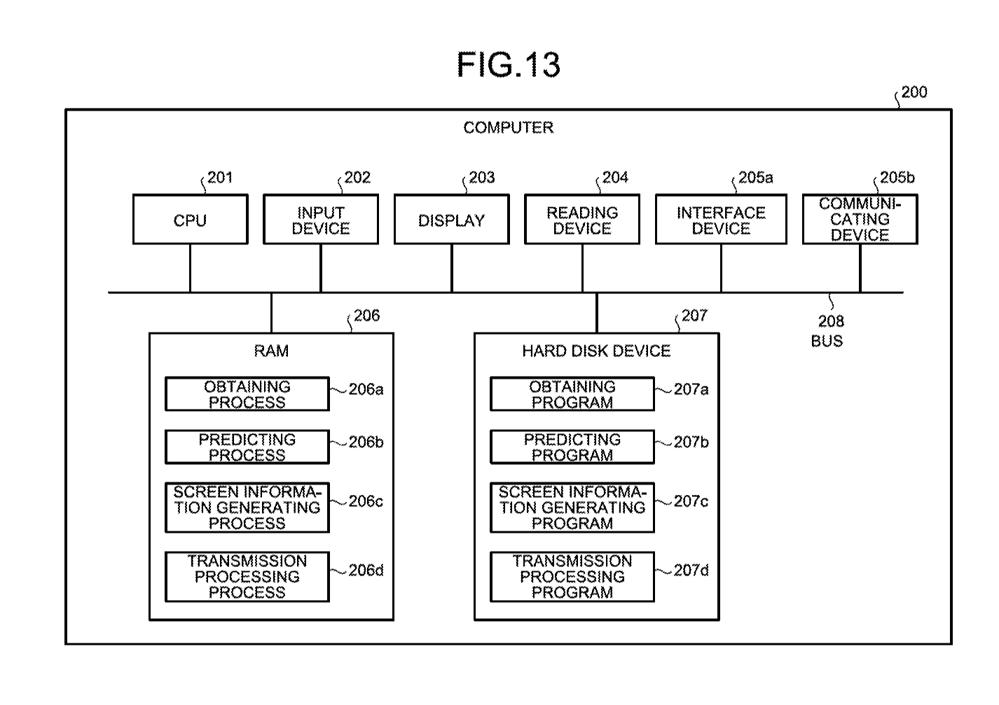

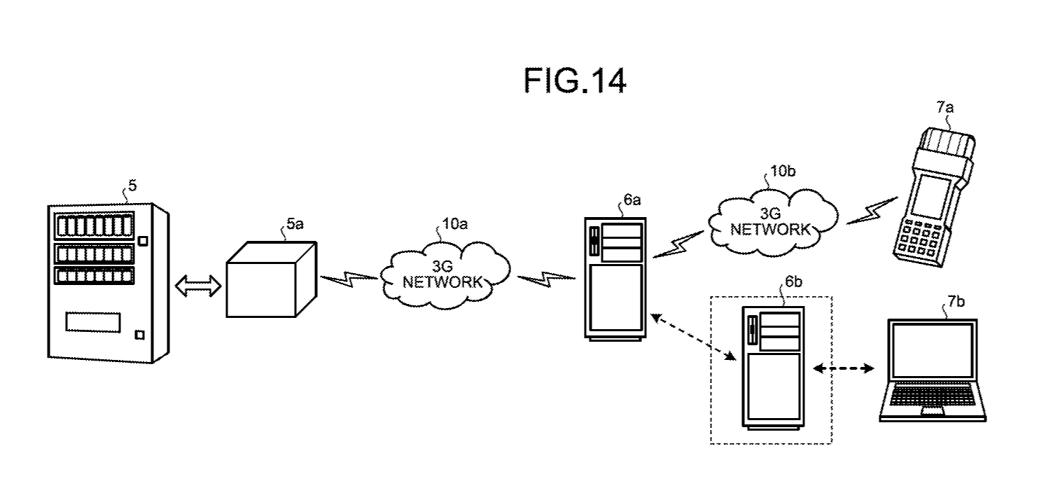

Next, an example of a hardware configuration of a computer that realizes the same functions as those of the processing apparatus 100 according to the embodiment described above will be explained. FIG. 13 is a diagram illustrating the example of the hardware configuration of the computer that realizes the same functions as those of the processing apparatus.

As illustrated in FIG. 13, a computer 200 includes a Central Processing Unit (CPU) 201 that performs various types of computing processes, an input device 202 that receives an input of data from the user, and a display 203. Further, the computer 200 includes a reading device 204 that reads computer programs (hereinafter, “programs”) or the like from a storage medium, an interface device 205a that exchanges data with another computer via a network, and a communicating device 205b. Further, the computer 200 also includes a Random Access Memory (RAM) 206 that temporarily stores therein various types of information and a hard disk device 207. Further, the devices 201 to 207 are connected to a bus 208.

The hard disk device 207 includes an obtaining program 207a, a predicting program 207b, a screen information generating program 207c, and a transmission processing program 207d. The CPU 201 reads the obtaining program 207a, the predicting program 207b, the screen information generating program 207c, and the transmission processing program 207d and loads the read programs into the RAM 206.

The obtaining program 207a functions as an obtaining process 206a. The predicting program 207b functions as a predicting process 206b. The screen information generating program 207c functions as a screen information generating process 206c. The transmission processing program 207d functions as a transmission processing process 206d.

Processes performed by the obtaining process 206a correspond to the processes performed by the obtaining unit 151. Processes performed by the predicting process 206b correspond to the processes performed by the predicting unit 152. Processes performed by the screen information generating process 206c correspond to the processes performed by the screen information generating unit 153. The transmission processing process 206d corresponds to the transmission processing unit 154.

In this situation, the obtaining program 207a, the predicting program 207b, the screen information generating program 207c, and the transmission processing program 207d do not necessarily have to be stored in the hard disk device 207 to begin with. For example, it is acceptable to have the programs stored in a “portable medium” such as a flexible disk (FD), a Compact Disk Read-Only Memory (CD-ROM), a Digital Versatile Disk (DVD), a magneto-optical disk, an Integrated Circuit (IC) card, or the like that can be inserted into the computer 200. Further, it is also acceptable to arrange the computer 200 to read and execute the programs 207a to 207d.

It is possible to provide the sales information of the vending machine.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium, having stored therein a processing computer program that causes a computer to execute a process comprising:
obtaining sales information from a control box of the vending machine which is connected to the computer via an interface compliant with an RS-232C standard;
generating data of a screen corresponding to a specific path and including the sales information of the vending machine on a basis of the obtained sales information; and
transmitting the data to a terminal, when having received a display request including a designation of the specific path, from the terminal.

2. The non-transitory computer-readable recording medium according to claim 1, wherein the sales information is obtained from the control box either in a Japan Vending Machine Manufacturers Association (JVMA) format or in a Vender Control Coca-Cola System (VCCS) format.

3. The non-transitory computer-readable recording medium according to claim 1, wherein the computer and the terminal are connected to each other via a Virtual Private Network (VPN).

4. The non-transitory computer-readable recording medium according to claim 1, wherein the specific path is unique to the screen including the sales information of the vending machine and is different from any of other paths corresponding to screens including sales information of other vending machines.

5. The non-transitory computer-readable recording medium according to claim 1, wherein the data is data in a HyperText Markup Language (HTML) format and is displayed by a web browser on the terminal.

6. The non-transitory computer-readable recording medium according to claim 1, the process further comprising identifying a predicted sold-out date of a commercial item on a basis of the sales information.

7. The non-transitory computer-readable recording medium according to claim 6, the process further comprising transmitting a notification to a second terminal, when a change is made to a predicted sold-out date of a specific commercial item on a basis of the sales information, the notification including information about a predicted sold-out date of the specific commercial item after the change.

8. The non-transitory computer-readable recording medium according to claim 7, wherein the notification includes information about the specific path.

9. A processing method comprising:
obtaining sales information from a control box of the vending machine which is connected to a computer via an interface compliant with an RS-232C standard, using a processor of the computer;
generating data of a screen corresponding to a specific path and including the sales information of the vending machine on a basis of the obtained sales information, using the processor; and
transmitting the data to a terminal, when having received a display request including a designation of the specific path, from the terminal, using the processor.

10. The processing method according to claim 9, wherein the sales information is obtained from the control box either in a Japan Vending Machine Manufacturers Association (JVMA) format or in a Vender Control Coca-Cola System (VCCS) format.

11. The processing method according to claim 9, wherein the computer and the terminal are connected to each other via a Virtual Private Network (VPN).

12. The processing method according to claim 9, wherein the specific path is unique to the screen including the sales information of the vending machine and is different from any of other paths corresponding to screens including sales information of other vending machines.

13. The processing method according to claim 9, wherein the data is data in a HyperText Markup Language (HTML) format and is displayed by a web browser on the terminal.

14. The processing method according to claim 9, the processing method further comprising identifying a predicted sold-out date of a commercial item on a basis of the sales information.

15. The processing method according to claim 14, the processing method further comprising transmitting a notification to a second terminal, when a change is made to a predicted sold-out date of a specific commercial item on a basis of the sales information, the notification including information about a predicted sold-out date of the specific commercial item after the change.

16. A processing apparatus, comprising:
a processor that executes a process comprising:
obtaining sales information from a control box of the vending machine which is connected to the processing apparatus via an interface compliant with an RS-232C standard;
generating data of a screen corresponding to a specific path and including the sales information of the vending machine on a basis of the obtained sales information; and
transmitting the data to a terminal, when having received a display request including a designation of the specific path, from the terminal.

17. A processing apparatus comprising:
a processor that executes a process comprising:
obtaining sales information from a control box of a vending machine, the control box connecting to the processing apparatus;
generating a file of a screen corresponding to a specific path and including the sales information of the vending machine on a basis of the obtained sales information;
transmitting the file to a terminal, when having received a display request including a designation of the specific path, from the terminal, wherein
the processing apparatus is provided on an inside of a housing of the vending machine while being positioned in a vicinity of the control box,
a communicating apparatus that is connected to the processing apparatus and is configured to mediate communication between the processing apparatus and the terminal is provided in a vicinity of a commercial-item display region of the vending machine, and
of the housing of the vending machine, at least a part of such a housing section that encloses the commercial-item display region therein is configured by using a material that is able to transmit a communication radio wave.

18. A vending machine comprising:
a processing unit that manages sales information of the vending machine;
a wireless communicating unit that obtains the sales information from the processing unit and that wirelessly transmits information generated on a basis of the obtained sales information, wherein
the wireless communicating unit is arranged in a region where wireless communication with an outside is possible via a member that is able to transmit a wireless signal.

19. The vending machine according to claim 18, wherein the region is a display region for a commercial-item sample.

20. The vending machine according to claim 18, wherein the member is either a transparent member or a translucent member that arranges the commercial-item sample to be visible.
